(19) United States
(12) Patent Application Publication
(10) Pub. No.: US 2018/0060404 A1
(43) Pub. Date: Mar. 1, 2018

(54) SCHEMA ABSTRACTION IN DATA ECOSYSTEMS

(71) Applicant: LinkedIn Corporation, Mountain View, CA (US)

(72) Inventors: Eric Li Sun, Fremont, CA (US); Shirshanka Das, San Jose, CA (US)

(73) Assignee: LinkedIn Corporation, Mountain View, CA (US)

(21) Appl. No.: 15/249,959

(22) Filed: Aug. 29, 2016

(51) Int. Cl. G06F 17/30

(52) U.S. Cl. CPC G06F 17/30569; G06F 17/30528; G06F 17/30292

(57) ABSTRACT

The disclosed embodiments provide a system for performing data management. During operation, the system obtains a first schema with a first syntax for describing a first data set and a second schema with a second syntax for describing a second data set. Next, the system converts the first schema into a first standardized form with a standardized syntax and the second schema into a second standardized form with the standardized syntax. The system then outputs the first and second standardized forms for use in accessing the first and second data sets.

### BACKGROUND

### Field

The disclosed embodiments relate to data management. More specifically, the disclosed embodiments relate to techniques for performing schema abstraction in data ecosystems.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, data analytics may be used to assess past performance, guide business or technology planning, and/or identify actions that may improve future performance.

However, significant increases in the size of data sets have resulted in difficulties associated with collecting, storing, managing, transferring, sharing, analyzing, and/or visualizing the data in a timely manner. For example, conventional software tools, relational databases, and/or storage mechanisms may be unable to handle petabytes or exabytes of loosely structured data that is generated on a daily and/or continuous basis from multiple, heterogeneous sources. Instead, management and processing of “big data” may require massively parallel software running on a large number of physical servers. In addition, schemas for the data sets are typically tied to specific technologies for generating, storing, consuming, and/or otherwise handling the data, which may interfere with comparison of data sets across technologies, sharing of the data sets or schemas across the technologies, and/or mapping of related data elements among the data sets.

Consequently, big data analytics may be facilitated by mechanisms for efficiently collecting, storing, managing, compressing, transferring, sharing, analyzing, defining, and/or visualizing large data sets.

### BRIEF DESCRIPTION OF THE FIGURES

FIG. 1 shows a schematic of a system in accordance with the disclosed embodiments.

FIG. 2 shows a system for performing data management in accordance with the disclosed embodiments.

FIG. 3A shows an exemplary schema for a data set in accordance with the disclosed embodiments.

FIG. 3B shows an exemplary standardized form of a schema for a data set in accordance with the disclosed embodiments.

FIG. 4 shows an exemplary standardized form of a schema for a data set in accordance with the disclosed embodiments.

FIG. 5 shows a flowchart illustrating the process of performing data management in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

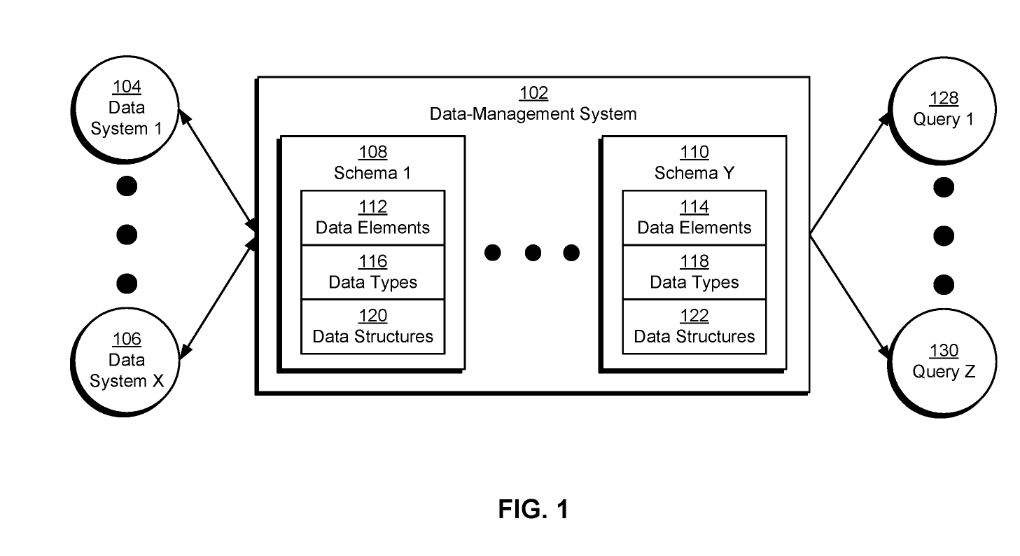

The disclosed embodiments provide a method, apparatus, and system for processing data. As shown in FIG. 1, the system may be a data-management system 102 that interfaces with a set of data systems (e.g., data system 1 104, data system x 106) and aggregates a set of schemas (e.g., schema 1 108, schema y 110) for data sets in the data systems. The data systems may form a data ecosystem that is used to store, process, analyze, and/or visualize large sets of data. For example, the data ecosystem may include relational databases, graph databases, in-memory databases, data warehouses, distributed data stores, analytics platforms, machine learning platforms, execution environments, applications, and/or other data platforms or systems. In turn, information managed by the data-management system may be used to locate the data sets in the data ecosystem, analyze the structure of the data sets, identify owners of the data sets, and/or construct data lineages associated with the data sets.

Because multiple disparate, heterogeneous data systems are used with large numbers of data sets in a single data ecosystem, representations and/or definitions of the data sets may span multiple formats and/or syntaxes. For example, each data system may have a different data definition language (DDL) and/or data format for describing the structure and types of data in the data system. Such variations in schemas across the data ecosystem may interfere with efforts to understand, profile, verify, protect, associate, and/or otherwise use the data. For example, the use of two different syntaxes to describe two data sets on two data systems may result in significant overhead and/or manual effort in comparing the data sets, determining the structure of the data sets, and/or mapping between fields in the data sets.

In one or more embodiments, data-management system 102 includes functionality to standardize and consolidate schemas with different syntaxes from multiple data systems. More specifically, the data-management system may convert the schemas, data models, and/or other metadata for describing and/or defining data sets in the data systems into standardized forms that adhere to a common syntax. As described in further detail below, the standardized forms may represent data elements 112-114 (e.g., fields, columns, units of data, etc.), data types 116-118 (e.g., primitive types, complex types, etc.), and data structures 120-122 (e.g., organizations of data elements) in the schemas in a uniform fashion. In turn, the standardized forms may improve understanding, referencing, mapping, comparison, and/or other analysis of the data sets.

Data-management system 102 may also provide the standardized forms of the schemas in response to queries (e.g., query 1 128, query z 130) associated with the data sets. For example, the data-management system may match search terms in the queries to data elements 112-114, data types 116-118, data structures 120-122, and/or other information in the standardized forms. The data-management system may then return standardized forms of the matching schemas in response to the queries to enable additional analysis and management of the corresponding data sets.

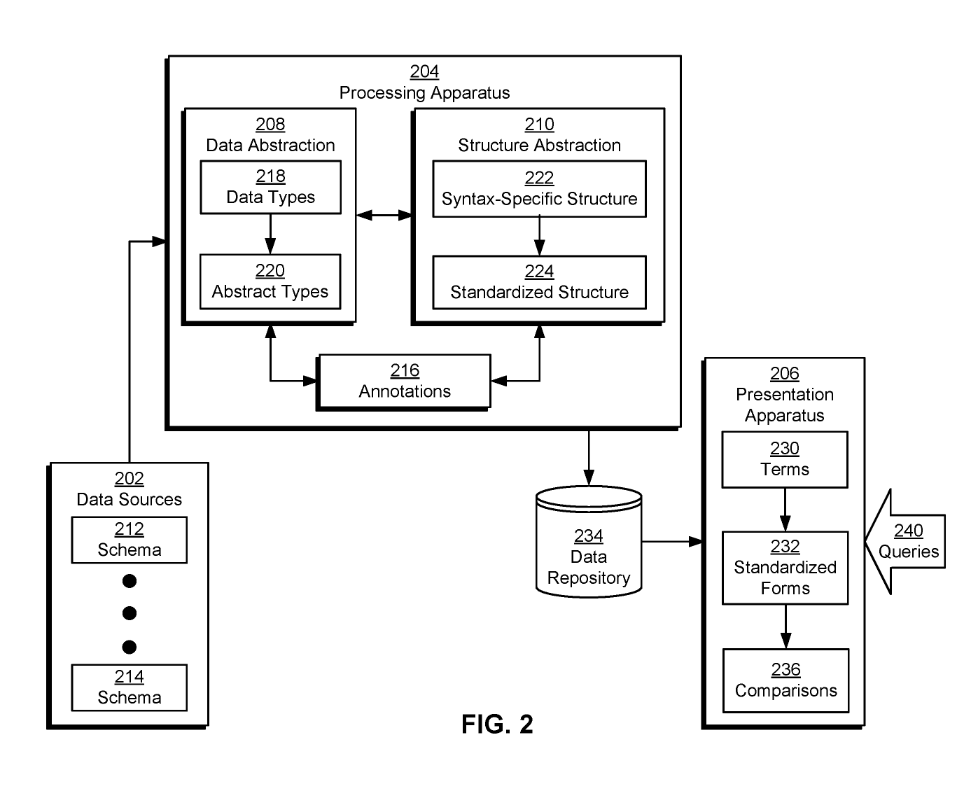

FIG. 2 shows a system for performing data management (e.g., data-management system 102 of FIG. 1) in accordance with the disclosed embodiments. The system includes a processing apparatus 204 and a presentation apparatus 206, both of which are described in further detail below.

Processing apparatus 204 may obtain a number of schemas 212-214 from one or more data sources 202. For example, the schemas may be uploaded to a data store accessible by the processing apparatus by owners or managers of data sets represented by the schemas. In another example, the processing apparatus may obtain the schemas directly from data systems used to store, process, analyze, and/or visualize the data sets, such as relational databases, graph databases, in-memory databases, data warehouses, distributed data stores, applications, analytics platforms, machine learning platforms, and/or execution environments. As a result, each schema may adhere to a syntax and/or format that is specific to the platform of the corresponding data system.

Next, processing apparatus 204 may convert schemas 212-214 into standardized forms 232 of the schemas that follow a common syntax and/or format. For example, the processing apparatus may reorganize, reformat, and/or rewrite the schemas in a way that decouples the schemas from their native syntaxes and formats and presents the schemas in an abstracted, uniform way. The standardized forms may then be delivered to presentation apparatus 206.

As shown in FIG. 2, processing apparatus 204 may convert schemas 212-214 into standardized forms 232 by performing a data abstraction 208 that converts native data types 218 in the schemas into a set of abstract types 220. In the data abstraction, the processing apparatus may convert platform-specific primitive types into generic types in the abstract types. Each generic type may represent a grouping of similar primitive types into a more abstract representation that captures the general use of the primitive types. In turn, the generic type may facilitate understanding and/or comparison of data elements associated with the primitive types. For example, the processing apparatus may convert platform-specific, numeric data types such as integers, longs, floats, and/or doubles into a generic type of “number.” As a result, the “number” type may improve the searching, identification, and comparison of numeric types in the data sets, independently of the native representations of the numeric types in the corresponding data systems.

During data abstraction 208, processing apparatus 204 may also match data patterns associated with data types 218 to use cases for the data types and include the use cases in the corresponding abstract types 220. The use cases may include domain-specific use cases, such as the use of email addresses, Uniform Resource Locators (URLs), user identifiers, and/or other types of data used with practical, real-world applications. The data patterns may include regular expressions, labels, field names, field values, data set names, data set locations, and/or other information that can be used to match a given data type in a schema to a use case of the data type. For example, a field in the schema with a data type of “string,” a field name containing the word “email,” and a value that matches the regular expression of “\b[A-Za-z0-9._%+−]+@[A-Za-z0-9.−]+\.[A-Za-z]{2,6}\b” may be matched to an “email address” use case. In turn, data abstraction of the field may involve the inclusion of an “email address” label in the generic type for the field.

Use cases for data types 218 may also include system-specific use cases, such as the use of data types associated with timestamps, file names, network addresses, and/or other types of data associated with a specific runtime environment, programming language, and/or platform. As with the domain-specific use cases, data patterns such as regular expressions, labels, field names, field values, data set names, data set locations, and/or other information may be matched to data types in the schema to identify system-specific use cases of the data types. For example, a field in the schema with a data type of “string,” a field name containing the word “address,” and a value that matches the regular expression of “\b((25[0-5]|2[0-4][0-9]|[01]?[0-9][0-9]?)(\.|$)){4}\b” may include an “Inet4Address” label in the corresponding generic type to link the data element to an “Inet4Address” object in a Java (Java™ is a registered trademark of Oracle America, Inc.) runtime environment. In another example, a field in the schema with a data type of “string” and a value that matches one or more regular expressions for timestamps may include a “time” label in the corresponding generic type. The “time” label may additionally specify the granularity of the timestamp (e.g., second or millisecond), the presence or absence of various date and time components (e.g., day, hour, date, etc.), and/or a certain formatting of the timestamp(s). In other words, data abstraction 208 may be used to provide additional context related to the usage of certain data types in schemas 212-214, which may improve understanding and/or comparison of the data sets represented by the schemas.

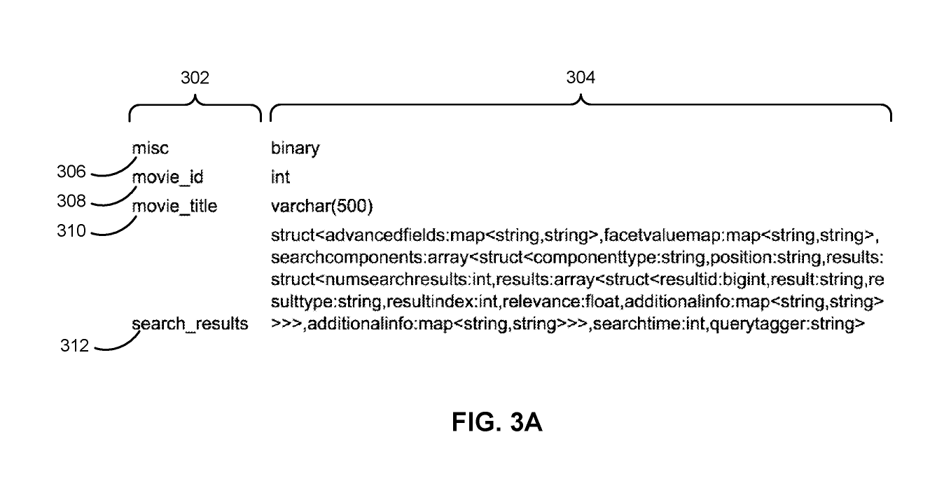

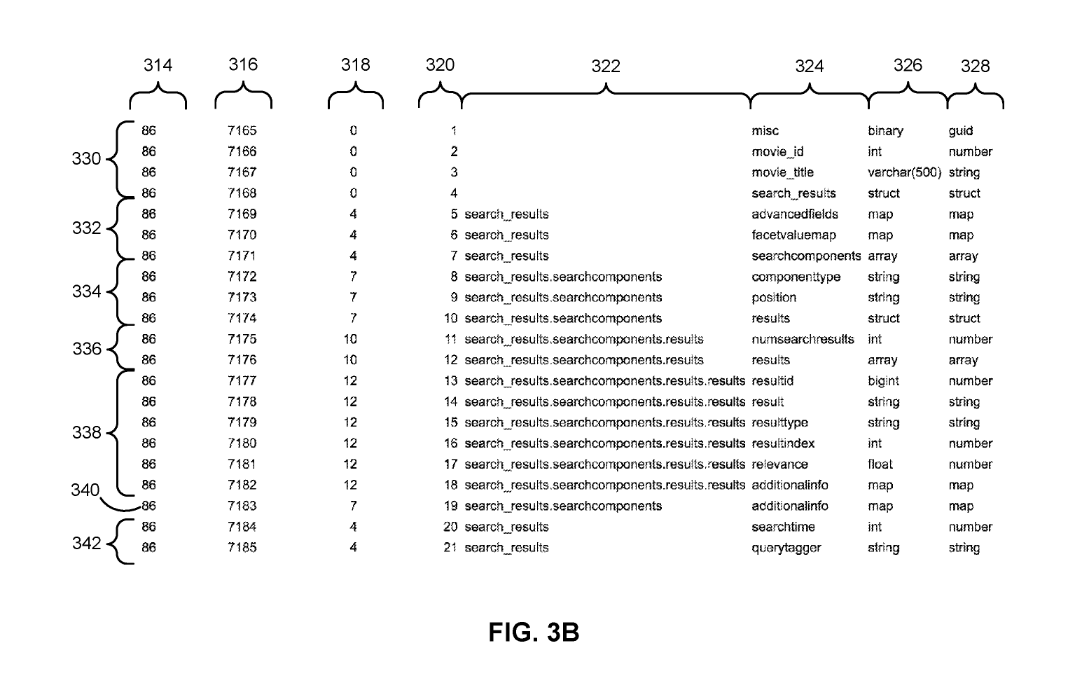

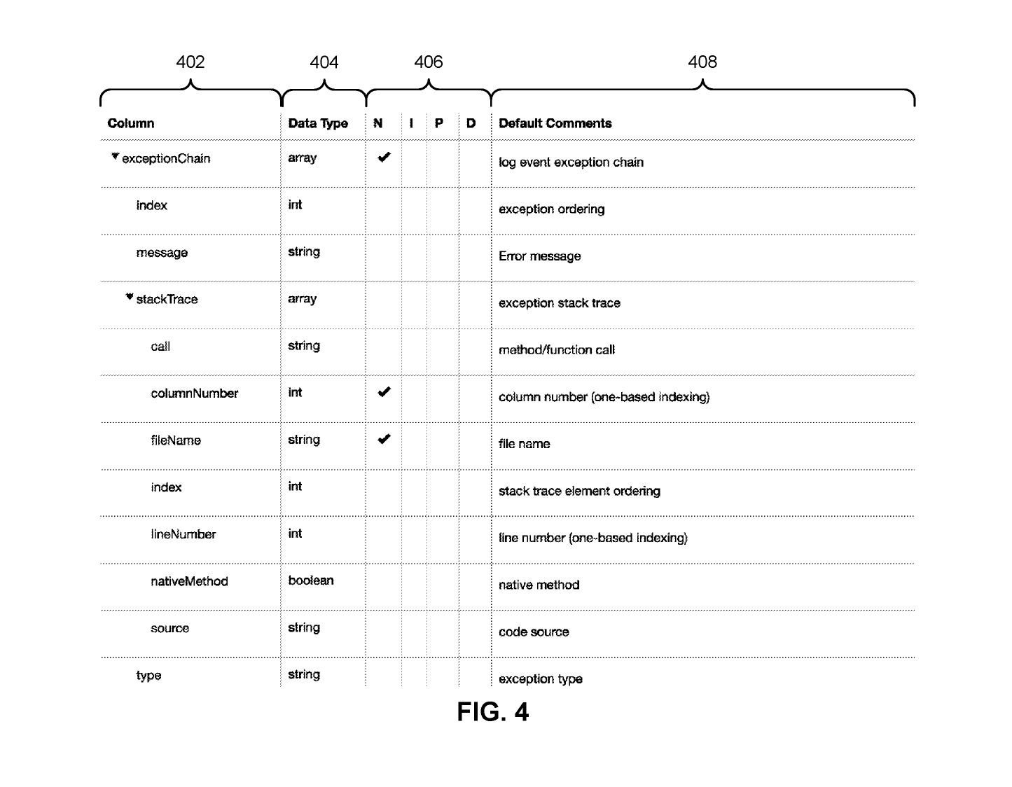

During conversion of schemas 212-214 into standardized forms 232, processing apparatus 204 may also perform a structure abstraction 210 that converts a syntax-specific structure 222 in each schema into a standardized structure 224. For example, the processing apparatus may use syntax and/or formatting rules associated with the schema to parse the schema and extract the structure of the data set from the schema. The processing apparatus may then use a standardized syntax to convert the structure into a flattened structure that includes a set of field names and a set of paths associated with the field names, as described in further detail below with respect to FIGS. 3A-3B. The processing apparatus may also, or instead, convert the structure into a standardized nested structure, as described in further detail below with respect to FIG. 4.

Processing apparatus 204 may then combine abstract types 220 and standardized structure 224 for each schema into a standardized form of the schema. For example, the processing apparatus may combine the abstract types, the names of the corresponding fields, the name of the data set, and the standardized structure to produce the standardized form.

Processing apparatus 204 may additionally apply a number of annotations 216 to abstract types 220, standardized structure 224, and/or other components of standardized forms 232. As with other components of the standardized forms, the annotations may adhere to a common, standardized syntax or format.

Annotations 216 may provide additional information associated with the data sets represented by standardized forms 232. For example, the annotations may include domain-specific and/or system-specific use cases associated with data types 218 and/or abstract types 220, as described above. In another example, processing apparatus 204 may add profiling attributes (e.g., minimums, maximums, averages, percentiles, counts, sums, statistics, etc.) used in data profiling of the corresponding data sets to the corresponding fields in the standardized forms. In a third example, the processing apparatus may include an annotation that maps a field or structure in a standardized form of a schema to a corresponding field or structure in the standardized form of a different schema. The mapping may equate the two fields, link the two fields via a mathematical or logical relationship, and/or otherwise connect the fields with one another.

After standardized forms 232 are created, processing apparatus 204 may store the standardized forms in a data repository 234 for subsequent retrieval and use. For example, the processing apparatus may store files and/or data structures containing the standardized forms in a database, data warehouse, cloud storage, distributed filesystem, network-attached storage (NAS), and/or other data-storage mechanism providing the data repository.

Presentation apparatus 206 may then output standardized forms 232 in response to queries 240 associated with the data sets. For example, the presentation apparatus 206 may obtain one or more terms 230 (e.g., search terms) from the queries and match the terms to data set names, data set locations, fields, abstract types 220, annotations 216, and/or other information in one or more standardized forms in data repository 234. The presentation apparatus may then display, export, and/or otherwise output the standardized form(s) in response to the queries. The presentation apparatus may additionally, or alternatively, provide functionality for browsing, filtering, and/or sorting a list of schemas and outputting standardized forms in response to the browsing, filtering, and/or sorting behavior.

Presentation apparatus 206 may also output comparisons 236 of two or more standardized forms 232. For example, processing apparatus 204 and/or another component of the system may compare a number of standardized forms for similarities in standardized structure 224, abstract types 220, field names, data set names, annotations 216, and/or other information used to describe the corresponding data sets. The component may use the comparison to generate similarity scores for the standardized forms; identify similar or identical standardized structures 224, abstract types 220, annotations 216, or fields in the standardized forms; and/or generate additional output related to the comparison. The presentation may then display, export, and/or otherwise provide the output to further understanding and use of the data sets.

By abstracting schemas 212-214 with different syntaxes into standardized forms 232 that adhere to a single, uniform syntax, the system of FIG. 2 may reduce the overhead and/or manual analysis required to use the corresponding data sets. In turn, the system may expedite data profiling, security checks, data discovery, code generation, automation, and/or other operations related to management and use of data in data ecosystems.

Those skilled in the art will appreciate that the system of FIG. 2 may be implemented in a variety of ways. First, processing apparatus 204, presentation apparatus 206, and/or data repository 234 may be provided by a single physical machine, multiple computer systems, one or more virtual machines, a grid, one or more databases, one or more filesystems, and/or a cloud computing system. The processing and presentation apparatuses may additionally be implemented together and/or separately by one or more hardware and/or software components and/or layers.

Second, processing apparatus 204 may use a number of techniques to convert schemas 212-214 into standardized forms 232. For example, the processing apparatus may use one or more configuration files containing rules for transforming native data types, syntax-specific structures, and/or other syntax or formatting in the schemas into the standardized syntax of the standardized forms. As a result, changes in schema syntaxes and/or data systems in the data ecosystem may be accommodated by adapting the configuration files to reflect the changes instead of requiring manual updates to hard-coded or static scripts that operate on the schemas.

FIG. 3A shows an exemplary schema for a data set in accordance with the disclosed embodiments. More specifically, FIG. 3A shows a platform-specific schema for the data set, such as a schema produced by an Apache Hive data system. The schema of FIG. 3A includes a number of columns 302-304 and a set of fields 306-312 in the data set.

Column 302 may include names of fields 306-312, and column 304 may include data types of the fields. For example, field 306 may have a name of “misc” and a data type of “binary,” field 308 may have a name of “movie_id” and a type of “int,” field 310 may have a name of “movie_title” and a type of “varchar(500)”, and field 312 may have a name of “search_results” and a complex, nested data type. Because the nested structure associated with field 312 is described in a single string without additional formatting, a user may have difficulty understanding the organization of the data set as represented by the schema of FIG. 3A.

FIG. 3B shows an exemplary standardized form of a schema for a data set in accordance with the disclosed embodiments. In particular, FIG. 3B shows a standardized form of the schema of FIG. 3A. The standardized form of FIG. 3B includes a number of columns 314-328 and a number of rows 330-342. As a result, the standardized form may store the schema in a tabular, flattened structure, with columns 314-328 representing different attributes of the data set and rows 330-342 representing fields (e.g., fields 306-312) in the data set.

Column 314 may include a numeric identifier for the data set, which is set to the same value of “86” for all rows in the standardized form. Column 316 may specify unique identifiers for the fields in the data set, which range from “7165” to “7185.” For example, numeric values in column 316 may be used to identify the corresponding fields within a much larger set of fields from multiple data sets with the standardized form. Consequently, columns 314-316 may be used to organize standardized forms of the data sets under a single tabular data structure.

On the other hand, column 320 may include an identifier that can be used to reference and/or sort the fields within the data set. As a result, values of “1” to “21” in column 320 may enumerate the fields in the data set.

Columns 318, 322 and 324 may describe the structure of the data set. Column 324 may include the name of a field at a given level in the structure, column 318 may use values in column 320 to identify “parent” fields in the structure, and column 322 may provide a path for each parent field.

As shown in FIG. 3B, rows 330 may represent top-level fields in the data set. As a result, rows 330 may have field names of fields 306-310 in column 324, empty parent fields in column 322, and values of 0 in column 318.

Subsequent rows 332-342 in the standardized form may describe the nested structure of field 312 (e.g., “search_results”). Rows 332 and 342 may represent five fields in a first level of nesting under field 312. As a result, the rows may list, in column 318, the identifier of field 312 (i.e., “4”) from column 320. The rows may also contain the name of field 312 (i.e., “search_results”) as a “path” for the fields in column 322. The rows may then list distinct field names of “advancedfields,” “facetvaluemap,” “searchcomponents,” “searchtime,” and “querytagger” for the corresponding fields in column 324.

Rows 334 and 340 may represent four fields in a second level of nesting under field 312. The rows may list a value of “7” in column 318 and a path of “search_results.searchcomponents” in column 322, indicating that the fields are nested under a parent field with an identifier of 7 and a fully qualified name of “search_results.searchcomponents.” Field names of the fields may be listed as “componenttype,” “position,” “results,” and “additionalinfo” under column 324.

Rows 336 may represent two fields in a third level of nesting under field 312. The rows may include a value of 10 in column 318 and a path of “search_results.searchcomponents.results” in column 322, indicating that the fields are nested under a parent field with an identifier of 10 and a fully qualified name of “search_results.searchcomponents.results.” Field names of the fields may be listed as “numsearchresults” and “results” under column 324.

Rows 338 may represent six fields in a fourth and final level of nesting under field 312. The rows may list a value of 12 in column 318 and a path of “search_results.searchcomponents.results.results” in column 322, which specifies that the fields are nested under a parent field with an identifier of 12 and a fully qualified name of “search_results.searchcomponents.results.results.” Field names of the fields may include “resultid,” “result,” “resulttype,” “resultindex,” “relevance,” and “additionalinfo.”

By referencing parent fields and providing paths to the fields in columns 318 and 322, the standardized form of FIG. 3B may capture the complex, nested structure of the data set in a flattened structure that is significantly easier to understand than the schema of FIG. 3A. The standardized form may also be used to generate a graphical representation of the schema, as described below with respect to FIG. 4.

Finally, column 326 may list data types of the corresponding fields, and column 328 may list abstract types associated with the data types. For example, numeric primitive types such as “int,” “bigint,” and “float” in column 326 may be converted into a generic type of “number” in column 328. Similarly, character-based primitive types such as “varchar(500)” and “string” in column 326 may be converted into the same generic type of “string” in 328. Such abstraction of data types in the standardized form may facilitate platform-neutral analysis, comparison, and understanding of the data types and corresponding data elements, as discussed above.

FIG. 4 shows an exemplary standardized form of a schema for a data set in accordance with the disclosed embodiments. More specifically, FIG. 4 shows a graphical representation that is generated from a standardized form with a standardized syntax, such as the syntax described above with respect to FIG. 3B. The graphical representation may be displayed in a graphical user interface (GUI) in response to a query containing a term that is matched to the standardized form. For example, the graphical representation may be displayed by presentation apparatus 206 of FIG. 2 in response to a search containing a data set name, data set location, field name, and/or other attribute that can be found in the standardized form.

The graphical representation includes a number of columns 402-408 with information from the standardized form. Column 402 may include field names of fields in the data set, and column 404 may include data types (e.g., native data types) of the fields. Field names under column 402 may be formatted to represent a nested structure in the data set. For example, column 402 may indicate that the “exceptionChain” field is at the top level of the structure, field names of “index,” “message,” “stackTrace,” and “type” are nested under the “exceptionChain” field, and field names of “call,” “columnNumber,” “filename,” “index,” “lineNumber,” “nativeMethod,” and “source” are further nested the “stackTrace” field.

Columns 406 may provide values of a set of flags associated with the fields, such as a nullable flag (i.e., “N”) indicating if the field can have a null value, an indexed flag (i.e., “I”) indicating if the field is indexed, a partitioned flag (i.e., “P”) indicating if the field is partitioned, and a distributed flag (i.e., “D”) indicating if the field is distributed. Column 408 may provide comments associated with the fields, such as descriptions and/or definitions of the fields. For example, column 408 may include information provided by creators of the data sets. Column 408 may also, or instead, include annotations that are generated by a processing apparatus, such as processing apparatus 204 of FIG. 2. The annotations may provide additional context related to data types in column 404, such as domain-specific and/or system-specific use cases of the data types. The annotations may also include profiling attributes such as statistics calculated from the corresponding fields. The profiling attributes may reference other data sets containing the statistics, or the profiling attributes may be used to create additional fields in the data set.

As mentioned above, the schema may be converted into a number of standardized forms, including the flattened structure of FIG. 3B. The schema of FIG. 4B may also, or instead, be converted into the following standardized form:

{

“doc”: “log event exception chain”,
“name”: “exceptionChain”,
“type”: [ {

“items”: {

“fields”: [ {

“doc”: “exception ordering”,
“name”: “index”,
“type”: “int”

}, {

“doc”: “error message”,
“name”: “message”,
“type”: “string”

}, {

“doc”: “exception stack trace”,
“name”: “stackTrace”,
“type”: {

“items”: {

“fields”: [ {

“doc”: “method/function call”,
“name”: “call”,
“type”: “string”

}, {

“default”: null,
“doc”: “column number (one-based
indexing)”,
“name”: “columnNumber”,
“type”: [ “null”, “int” ]

}, {

“doc”: “file name”,
“name”: “fileName”,
“type”: [ “string”, “null” ]

}, {

“doc”: “stack trace element ordering”,
“name”: “index”,
“type”: “int”

}, {

“doc”: “line number (one-based
indexing)”,
“name”: “lineNumber”,
“type”: “int”

}, {

“default”: false,
“doc”: “native method”,
“name”: “nativeMethod”,
“type”: “boolean”

}, {

“doc”: “code source”,
“name”: “source”,
“type”: “string”

} ],
“name”: “StackTraceFrame”,
“type”: “record”

},
“type”: “array”

}

}, {

“doc”: “exception type”,
“name”: “type”,
“type”: “string”

} ],
“name”: “EventException”,
“type”: “record”

},
“type”: “array”

},
“null”

]}

The standardized form above may include a JavaScript Object Notation (JSON) representation of the schema. In the JSON representation, values associated with “name” may be used to populate column 402, values associated with “type” may be used to populate column 404, values of “null” under “type” may be used to populate columns 406, and values associated with “doc” may be used to populate column 308. Brackets and/or braces in the JSON representation may be used to describe nesting of data in the data set. The JSON representation may thus be used as another abstraction of the schema, in conjunction with or separately from the flattened structure of FIG. 3B.

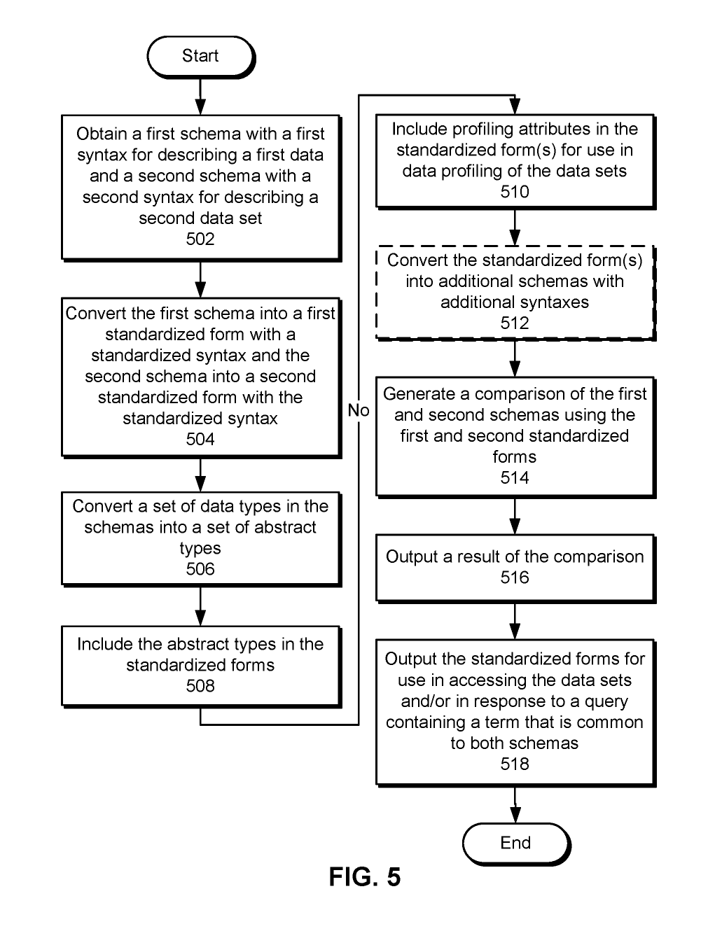

FIG. 5 shows a flowchart illustrating the process of performing data management in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

Initially, a first schema with a first syntax for describing a first data set and a second schema with a second syntax for describing a second data set are obtained (operation 502). The first and second schemas may be associated with data sets from disparate data systems, such as relational databases, graph databases, in-memory databases, data warehouses, distributed data stores, applications, analytics platforms, machine learning platforms, and/or execution environments.

Next, the first schema is converted into a first standardized form with a standardized syntax, and the second schema is converted into a second standardized form with the same standardized syntax (operation 504). For example, the first and second schemas may be converted into a flattened structure containing a set of field names and a set of paths associated with the field names, which are used to capture nested structures in the schemas. One or both schemas may also, or instead, be converted into a standardized nested structure, such as a JSON representation.

A set of data types in the schemas are also converted into a set of abstract types (operation 506). For example, a platform-specific primitive type in a schema may be converted into a generic type (e.g., “number,” “string”) that encompasses multiple related platform-specific types (e.g., “int,” “float,” “double,” “bigint,” “Integer,” “varchar,” etc.). In another example, a use case (e.g., domain-specific use case, system-specific use case) associated with a data type may be included in a corresponding abstract type based on a data pattern (e.g., regular expression, field name, data set name, data set location, etc.) associated with the data type. The abstract types are then included in the standardized forms (operation 508). For example, the abstract types may be added as columns, attribute-value pairs, and/or other units of information to the standardized forms.

Profiling attributes are also included in one or both standardized forms for use in data profiling of the data sets (operation 510). For example, a minimum, maximum, average, percentile, sum, count, and/or other statistic may be added as an annotation of a field in the standardized form(s). In turn, the annotation may allow data profiling operations or results for the data set to be associated to the field in a standardized, uniform fashion.

The standardized forms may optionally be converted into additional schemas with additional syntaxes (operation 512). For example, a standardized form may be created from a schema for a data set in a data warehouse. The standardized form may then be used to create a schema with a different syntax that is specific to a relational database. As a result, the standardized form may facilitate cross-platform sharing and/or use of the corresponding data set.

A comparison of the first and second schemas is further generated (operation 516), and a result of the comparison is outputted (operation 516). For example, the schemas may be compared for similarities in data types, use cases, structures, field names, data set names, and/or other attributes. The result of the comparison may then be outputted as a score and/or a list of similar or identical fields, structures, and/or data types in the data sets.

Finally, the standardized forms are outputted for use in accessing the data sets and/or in response to a query containing a term that is common to both schemas (operation 518). For example, the standardized forms may be accessed through a GUI. The GUI may provide browsing, searching, sorting, and/or filtering functionality that allows users to locate schemas that are relevant to the users' needs. The GUI may also display, export, and/or otherwise provide standardized forms of schemas that match search terms, filters, and/or other parameters provided by the users to improve the users' understanding of the schemas and/or perform additional processing or analysis of the corresponding data sets.

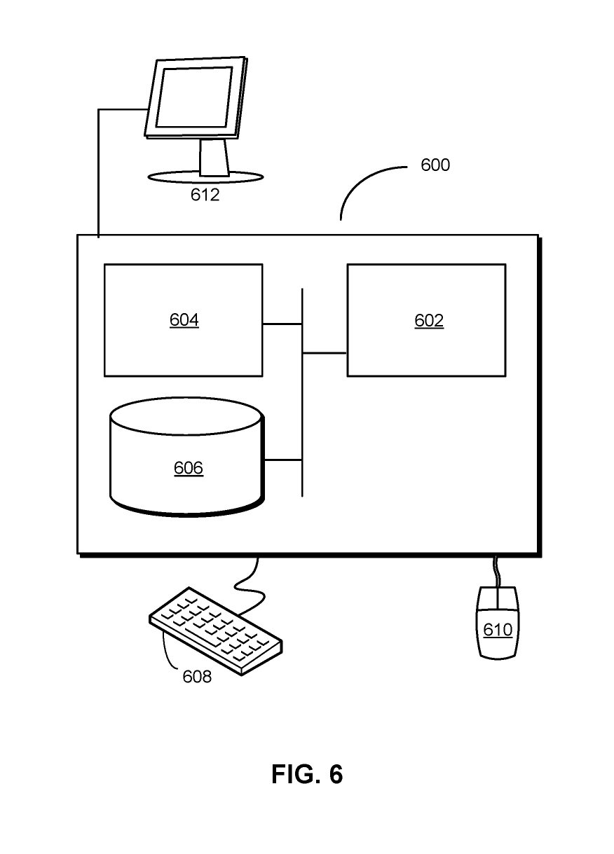

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/0) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for performing data management. The system may include a processing apparatus and a presentation apparatus, one or both of which may alternatively be termed or implemented as a module, mechanism, or other type of system component. The processing apparatus may obtain a first schema with a first syntax for describing a first data set and a second schema with a second syntax for describing a second data set. Next, the processing apparatus may convert the first schema into a first standardized form with a standardized syntax and the second schema into a second standardized form with the standardized syntax. The presentation apparatus may then output the first and second standardized forms for use in accessing the first and second data sets and/or in response to a query containing a term that is common to both schemas.

In addition, one or more components of computer system 600 may be remotely located and connected to the other components over a network. Portions of the present embodiments (e.g., presentation apparatus, processing apparatus, data repository, etc.) may also be located on different nodes of a distributed system that implements the embodiments. For example, the present embodiments may be implemented using a cloud computing system that provides data management functionality for data sets in a set of remote data systems.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a first schema with a first syntax for describing a first data set and a second schema with a second syntax for describing a second data set;
converting, by a computer system, the first schema into a first standardized form with a standardized syntax and the second schema into a second standardized form with the standardized syntax; and
outputting the first and second standardized forms for use in accessing the first and second data sets.

2. The method of claim 1, further comprising:
converting a set of data types in the first schema into a set of abstract types; and
including the abstract types in the first standardized form.

3. The method of claim 2, wherein converting the set of data types into the set of abstract types comprises at least one of:
converting a primitive type in the first schema into a generic type; and
including a use case associated with a data type in a corresponding abstract type based on a data pattern associated with the data type.

4. The method of claim 3, wherein the use case comprises at least one of:
a domain-specific type; and
a system-specific type.

5. The method of claim 1, further comprising:
generating a comparison of the first and second schemas using the first and second standardized forms.

6. The method of claim 1, further comprising:
outputting the first and second standardized forms in response to a query comprising a term that is common to the first and second schemas.

7. The method of claim 1, further comprising:
converting the first standardized form into a third schema with a third syntax for describing the first data set.

8. The method of claim 1, further comprising:
including, in the first standardized form, a profiling attribute for use in data profiling of the first data set.

9. The method of claim 1, wherein the first standardized form stores a structure associated with the first schema in a flattened structure comprising a set of field names and a set of paths associated with the field names.

10. The method of claim 1, wherein the first standardized form stores a structure associated with the first schema in a standardized nested structure.

11. The method of claim 1, wherein the first and second schemas are obtained from at least one of:
a relational database;
a graph database;
an in-memory database;
a data warehouse;
a distributed data store;
an application;
an analytics platform;
a machine learning platform; and
a runtime environment.

12. An apparatus, comprising:
one or more processors; and
memory storing instructions that, when executed by the one or more processors, cause the apparatus to:
obtain a first schema with a first syntax for describing a first data set and a second schema with a second syntax for describing a second data set;
convert the first schema into a first standardized form with a standardized syntax and the second schema into a second standardized form with the standardized syntax; and
output the first and second standardized forms for use in accessing the first and second data sets.

13. The apparatus of claim 12, wherein the memory further stores instructions that, when executed by the one or more processors, cause the apparatus to:
convert a set of data types in the first schema into a set of abstract types; and
include the abstract types in the first standardized form.

14. The apparatus of claim 12, wherein converting the set of data types into the set of abstract types comprises at least one of:
converting a primitive type in the first schema into a generic type; and
including a use case associated with a data type in a corresponding abstract type based on a data pattern associated with the data type.

15. The apparatus of claim 14, wherein the use case comprises at least one of:
a domain-specific type; and
a system-specific type.

16. The apparatus of claim 12, wherein the memory further stores instructions that, when executed by the one or more processors, cause the apparatus to:
output the first and second standardized forms in response to a query comprising a term that is common to the first and second schemas.

17. The apparatus of claim 12, wherein the memory further stores instructions that, when executed by the one or more processors, cause the apparatus to:
generate a comparison of the first and second schemas using the first and second standardized forms.

18. The apparatus of claim 12, wherein the first standardized form stores a structure associated with the first schema in a flattened structure comprising a set of field names and a set of paths associated with the field names.

19. A system, comprising:
an processing module comprising a non-transitory computer-readable medium comprising instructions that, when executed, cause the system to:
obtain a first schema with a first syntax for describing a first data set and a second schema with a second syntax for describing a second data set; and
convert the first schema into a first standardized form with a standardized syntax and the second schema into a second standardized form with the standardized syntax; and
a presentation module comprising a non-transitory computer-readable medium comprising instructions that, when executed, cause the system to output the first and second standardized forms for use in accessing the first and second data sets.

20. The system of claim 19, wherein the non-transitory computer-readable medium of the processing module further comprises instructions that, when executed, cause the system to:
convert a set of data types in the first schema into a set of abstract types; and
include the abstract types in the first standardized form.
